(19) United States
(12) Patent Application Publication
(10) Pub. No.: US 2009/0304976 A1
(43) Pub. Date: Dec. 10, 2009

(54) METHOD FOR MANUFACTURING GLASS SUBSTRATE FOR MAGNETIC DISC

(75) Inventors: Katsuhiro MATSUMOTO, Tokyo (JP); Kazuo MANNAMI, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: ASAHI GLASS COMPANY, LIMITED, Chiyoda-ku (JP)

(21) Appl. No.: 12/504,401

(22) Filed: Jul. 16, 2009

Related U.S. Application Data
(63) Continuation of application No. PCT/JP08/63349, filed on Jul. 25, 2008.

(30) Foreign Application Priority Data
Aug. 2, 2007 (JP) 2007-203158

(51) Int. Cl. G06K 19/04; B24B 1/00

(52) U.S. Cl. 428/64.2; 451/41

(57) ABSTRACT

A method for producing a glass substrate for magnetic disk, which is capable of effectively removing a crack is provided. In the method for producing a glass substrate for magnetic disk, there were provided a preparation step 1 of preparing a circular glass substrate having a main surface, a back surface opposing to the main surface, an inner side surface defining a through-hole penetrating from the main surface to the back surface and an outer side surface opposing to the inner side surface; a pre-polishing step 2A of polishing the inner side surface and the outer side surface of the glass substrate; a lapping step 3 of lapping the polished glass substrate; and a post-polishing step 2B of polishing the inner side surface and the outer side surface of the lapped glass substrate.

### TECHNICAL FIELD

The present invention relates to a method for producing a glass substrate for magnetic disk constituting a magnetic disk to be used for a hard disk drive (HDD), etc. which is a magnetic disk device.

### BACKGROUND ART

Personal computers (PC) or the like are provided with a hard disk drive (HDD) or the like as an external storage device. In general, the hard disk drive has mounted thereon a magnetic disk which is known as a storage for computer or the like. The magnetic disk has a configuration in which a magnetic layer or the like is formed on an appropriate substrate, for example, an aluminum based alloy substrate.

On the other hand, a demand for mounting a hard disk drive on portable equipment has been increasing in recent years. Under such a circumstance, a glass substrate which is a material with high strength and high rigidity has been frequently used as a substrate for magnetic disk in place of a brittle metal substrate. Also, a glass substrate has attracted attention as a substrate for magnetic disk for a server application.

In general, in the production of the glass substrate, a disk-shaped substrate is cut out sheet by sheet from an original material such as, for example, a sheet-shaped glass. In subsequently performing various steps including a step of perforating a central portion of the cut-out original material substrate, a step of chamfering a corner part of the side surface (side wall surface), etc., there may be the case where a crack is formed on the side surface side. The crack, even if it is small, may grow thereafter if it is allowed to stand as it is, to reach a recording surface (magnetic layer forming surface) of a magnetic disk. This contributes to a cause of occurrence of defective products.

Under such a circumstance, unless a measure such as disposal at an early stage is adopted with respect to a crack-containing glass substrate, a lot of time and expenses consumed are wasted, which is hence uneconomical. Namely, it brings about an increase of the production costs of a glass substrate.

As a method for producing a glass substrate, there is proposed a method of performing a mirror polishing processing with respect to an end surface of the substrate after either a grinding step or a polishing step with respect to the substrate surface, or after each of these steps (see, for example, Patent Document 1).

Also, as the method for producing a glass substrate, there is proposed a method of performing a mirror polishing processing with respect to an end surface of the substrate after a lapping (grinding) step with respect to the substrate surface (see Patent Document 2).

Patent Document 1: JP-A-10-154321 (see [0040])

Patent Document 2: JP-A-2006-282429 (see [0098])

### DISCLOSURE OF THE INVENTION

### Problems that the Invention is to Solve

However, in each of the methods of Patent Documents 1 and 2, the mirror polishing processing step is provided only after the lapping step. Therefore, there is a problem that a fine crack which has been latent grows during the lapping step or polishing step in which a large force is applied to the glass substrate, leading to breakage of the glass substrate.

In view of the foregoing circumstances, an object of the invention is to provide a method for producing a glass substrate for magnetic disk, which is capable of effectively removing a crack.

### Means for Solving the Problems

The invention provides a method for producing a glass substrate for magnetic disk, which includes: a step of preparing a circular glass substrate having a main surface, a back surface opposing to the main surface, an inner side surface defining a through-hole penetrating from the main surface to the back surface and an outer side surface opposing to the inner side surface; a first polishing step of polishing the inner side surface and the outer side surface of the glass substrate; a step of lapping the polished glass substrate; and a second polishing step of polishing the inner side surface and the outer side surface of the lapped glass substrate.

It is preferred that the polishing amount to the glass substrate in the first polishing step is larger than the polishing amount to the glass substrate in the second polishing step.

Further, it is preferred that the inner side surface and the outer side surface of the glass substrate polished in the second polishing step are mirror surfaces having an arithmetic average roughness of from 50 nm to 100 nm.

In addition, the invention also includes a glass substrate for magnetic disk, produced by the foregoing method for producing a glass substrate for magnetic disk.

### ADVANTAGES OF THE INVENTION

In the method of the invention, since the first polishing step of polishing the inner side surface and the outer side surface of the glass substrate is provided before the lapping step, a crack which has occurred before the lapping step can be removed, thereby making it possible to produce an excellent glass substrate for magnetic disk.

There is a method in which a chemical strengthening step is provided after final polishing and a crack or the like is not concerned. However, in technologies of HAMR (heat assisted magnetic recording) or TAMR (thermal assisted magnetic recording) corresponding to a high capacity trend of 1 TB/inch² or more in the future, a high-temperature step is included, and an alkali having been ion exchanged is diffused into the glass substrate at the time of strengthening so that an effect to be brought by the chemical strengthening step is not obtained. According to the invention, it is possible to keep the strength of the substrate without performing the foregoing chemical strengthening step.

### BRIEF DESCRIPTION OF THE DRAWINGS

FIG. 1 is a flow chart showing steps of a method for producing a glass substrate for magnetic disk according to the invention.

FIG. 2(A) is a cross-sectional view of a glass substrate for magnetic disk according to the invention; FIG. 2(B) is an enlarged cross-sectional view of a relevant part thereof; and FIG. 2(C) is an enlarged cross-sectional view showing a state of being shallowly polished.

FIG. 3 is a perspective view showing a sheet-shaped glass before cutting out a glass substrate for magnetic disk according to the invention.

FIG. 4 is a graph showing the number of occurrence of a defect in a glass substrate for magnetic disk according to the invention (Invention Example) and a glass substrate for magnetic disk (Comparative Example) which is polished more shallowly than the former.

### DESCRIPTION OF REFERENCE NUMERALS AND SIGNS

1: Preparation step
2A: Pre-polishing step (pre-polishing step)
2B: Post-polishing step (post-polishing step)
3: Precise lapping step (lapping step)
10: Glass substrate
11: Main surface
12: Back surface
13: Through-hole
14: Inner side surface
15: Outer side surface
16: Chamfered part
20: Sheet-shaped glass
D₂: End surface processing depth in pre-polishing step
S: Maximum depth of crack
α: Crack

### BEST MODES FOR CARRYING OUT THE INVENTION

Embodiments of the invention are hereunder described in detail with reference to the accompanying drawings.

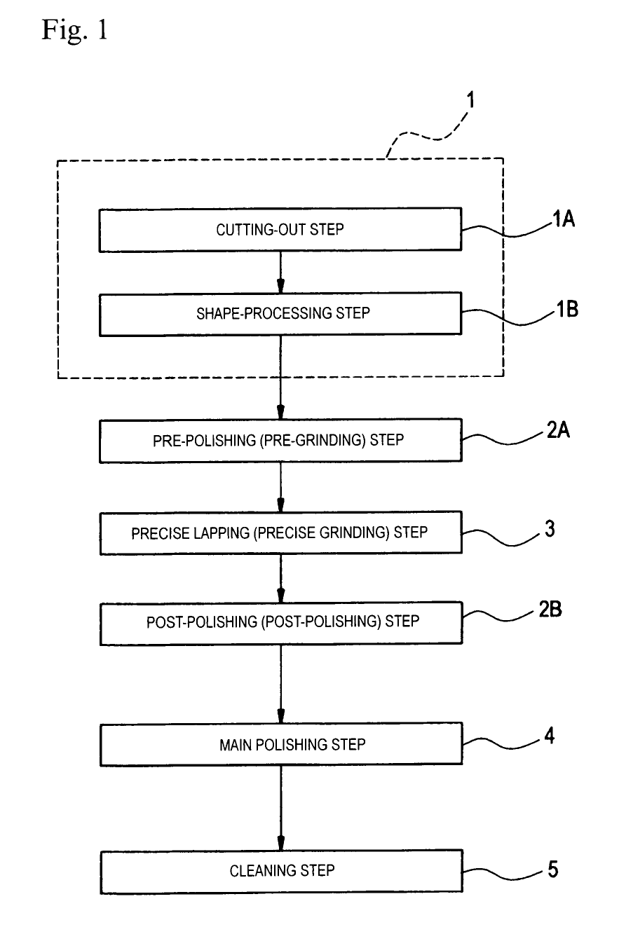

FIG. 1 is a flow chart showing a method for producing a glass substrate for magnetic disk according to an embodiment of the invention, and this method for producing a glass substrate for magnetic disk includes:

(1) a preparation step 1;

(2) a pre-polishing step (pre-polishing step with respect to an end surface) 2A;

(3) a precise lapping step (precise grinding step with respect to a main surface) 3;

(4) a post-polishing step (post-polishing step with respect to an end surface) 2B;

(5) a main polishing step (polishing step with respect to a main surface) 4; and

(6) a cleaning step 5.

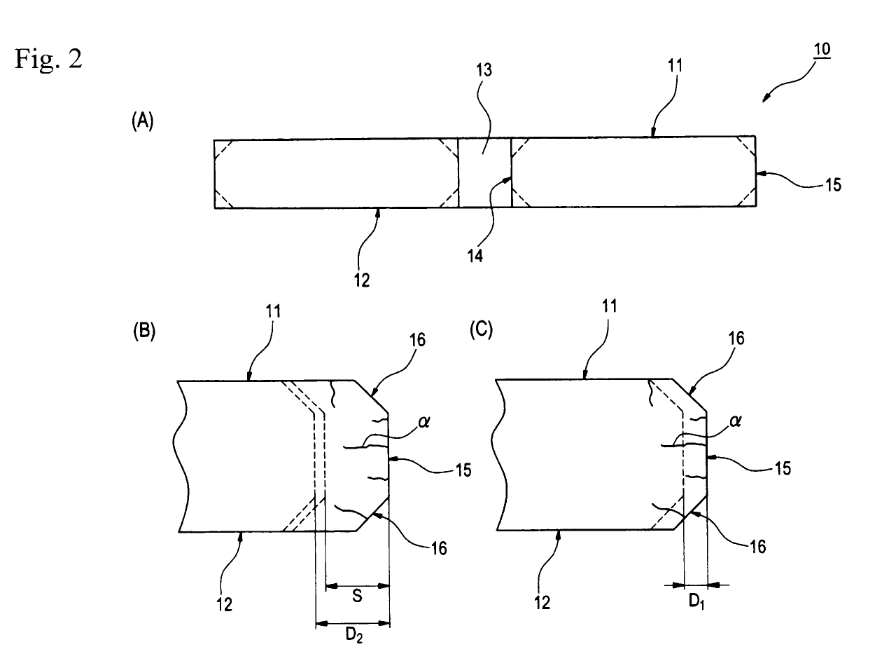

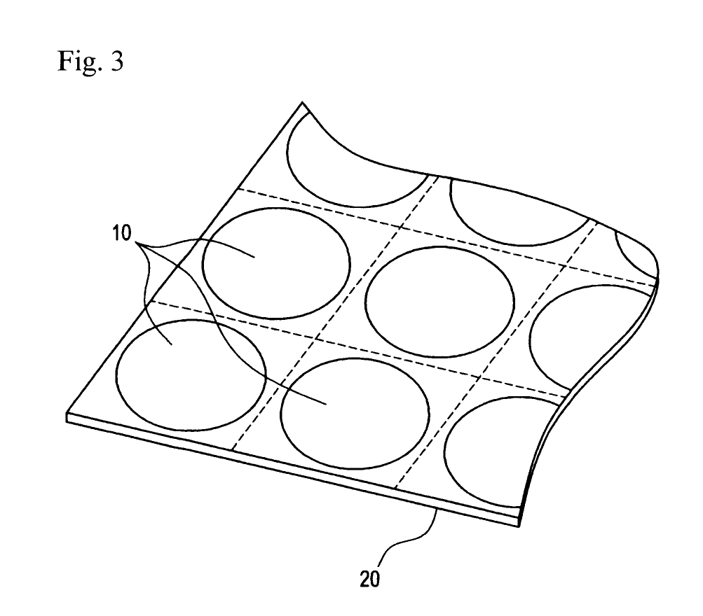

The preparation step 1 is a step of preparing a doughnut-shaped glass 10 (see FIGS. 2 and 3) and includes a cutting-out step 1A and a shape-processing step 1B.

As illustrated in FIG. 2(A), the doughnut-shaped glass 10 has a main surface 11, a back surface 12 opposing to this main surface 11, a through-hole 13 penetrating from the main surface 11 to the back surface 12, an inner side surface 14 defining this through-hole 13 and an outer side surface 15 opposing to this inner side surface 14. Further, as illustrated in FIG. 2(B), in the doughnut-shaped glass 10, the inner side surface 14 and the outer side surface 15 are chamfered, thereby forming a chamfered part 16 (the inner side surface 14 is not illustrated in FIG. 2(B)).

Referring to FIG. 3, the cutting-out step 1A is a step of cutting out a disk-shaped glass having a required dimension from a sheet glass 20. Specifically, in this embodiment, the cutting-out step 1A includes two steps of: coring for forming a through-hole 13 in the sheet glass (step of forming an inner hole serving as the through-hole 13); and scribing for cutting out the sheet glass in a circular form along the outer side surface 15 (step of cutting out in a circular shape constituted by the outer side surface 15).

In the shape-processing step 1B, as illustrated in FIG. 2(A), each of the disk-shaped glasses respectively cut out in the cutting-out step 1A is subjected to prescribed chamfering processing on the inner peripheral end surface 14 and the outer peripheral end surface 15 of the glass, thereby forming the chamfered part 16 (see FIG. 2(B)). Thus, the operation of the preparation step 1 is finished, and a large number of sheets of the doughnut-shaped glass 10 are completed. At that time, the end surface (i.e., the inner peripheral end surface 14 and the outer peripheral end surface 15, provided that the chamfered part 16 is also included) of the doughnut-shaped glass 10 have an arithmetic average roughness Ra of about 0.5 μm.

The pre-polishing step 2A is a pre-polishing step of polishing the end surface of the doughnut-shaped glass 10, i.e., the inner side surface 14 and the outer side surface 15 (also including the chamfered part 16). By providing the polishing step before the precise lapping step, a shallow crack on the end surface which has existed before the precise lapping step is removed before the precise lapping step. For that reason, it is possible to inhibit the shallow crack on the end surface which has existed before the precise lapping step from growing up to the magnetic layer forming surface due to the precise lapping step.

It is preferred that the doughnut-shaped end surface after the pre-polishing has an arithmetic average roughness Ra of from 50 nm to 100 nm.

Here, the depth (D₂) of the end surface to be subjected to polishing (pre-polishing) in this pre-polishing step 2A is set up in the following manner. Specifically, a large number of samples the same as the doughnut-shaped glass 10 are preliminarily produced by the same step as the foregoing preparation step 1. Then, cracks occurred in these samples are actually measured, and the maximum depth (S) of the actually occurred cracks is stored as a data. The polishing (pre-polishing) processing is to be performed to a required depth value D₂ which is set up so as to exceed the stored maximum depth value (S) (see FIG. 2(B)).

Next, in the precise lapping step 3, by subjecting the main surface 11 and the back surface 12 (hereinafter referred to as “main surface 11 and the like”) of the polished doughnut-shaped glass 10 to a lapping (precise grinding) treatment, a fine convex-concave shape formed on the main surface of the doughnut-shaped glass 10 in the shape-processing step 1B or the like among the already finished preparation step is reduced.

By subjecting the main surface 11 and the like of the doughnut-shaped glass 10 to a precise lapping treatment by the precise lapping (precise grinding) treatment of this precise lapping step 3 and subsequently performing a polishing (polishing) treatment of the main polishing (mirror finishing of the main surface) step 4, the mirror finished main surface 11 and the like can be obtained within a shorter period of time. The doughnut-shaped glass 10 which has thus finished the precise lapping step 3 is subjected to ultrasonic cleaning using a detergent.

It is preferred that the precise lapping (precise grinding) treatment of this precise lapping step 3 is carried out before the post-polishing (mirror finishing on the end surface) step 2B.

Next, the post-polishing step 2B constitutes a post-polishing step of polishing (mirror polishing) the end surface (i.e., the inner side surface 14, the outer side surface 15 and the chamfered part 16) with respect to the doughnut-shaped glass 10 in which the main surface 11 and the like have already been lapped in the precise lapping step 3, and is carried out by using, for example, an abrasive, a polishing brush, a polishing pad, a sponge, etc. This post-polishing step 2B may be carried out such that a polishing depth of the doughnut-shaped glass 10 is shallower than the polishing depth of the doughnut-shaped glass 10 when polished in the pre-polishing step 2A. That is, it is preferred that the polishing amount with respect to the glass substrate 10 in the pre-polishing step 2A is larger than the polishing amount with respect to the doughnut-shaped glass 10 in the post-polishing step 2B. This is because even a deeply occurred crack has been scraped off by pre-polishing in the pre-polishing step 2A so that it is not necessary to deeply polish. Specifically, it is preferred that the polishing amount on the end surface of the doughnut-shaped glass 10 is in the range of from 5 to 10 μm.

In this post-polishing step 2B, in the case of this embodiment, the doughnut-shaped glass 10 is polished by brush polishing while rotating the doughnut-shaped glass (the inner peripheral end surface 14, the outer peripheral end surface 15 and the chamfered part 16). In this post-polishing step 2B, the end surface of the doughnut-shaped glass 10 is polished so as to have a mirror surface having, for example, an arithmetic average roughness (Ra) of from 50 nm to 100 nm. Then, the main surface 11 of the doughnut-shaped glass 10 which has finished the end surface mirror finishing by the post-polishing step 2B is subjected to cleaning (for example, cleaning with water), thereby obtaining a glass substrate.

In this post-polishing step 2B, for example, polishing of the end surface may be carried out while a plurality of the doughnut-shaped glasses 10 are superposed one on another. On that occasion, for the purpose of avoiding the main surface 11 of the doughnut-shaped glass 10 from being scratched or the like, it is preferred that the polishing is performed, as in this embodiment, before the polishing step in the main polishing step 4 mentioned below, or before and after the mirror finishing in the main polishing step 4. By this post-polishing step 2B, the end surface 11 of the doughnut-shaped glass 10 can be prevented from the generation of dusts such as particles, etc. and, in addition, is processed into a mirror surface state with high strength.

Next, in the main polishing step 4, after completely removing off cracks occurred on the end surface (the outer side surface 15 and the chamfered part 16) or the like by the polishing treatment in the pre- and post-polishing steps 2A and 2B, polishing processing and mirror finishing with respect to the main surface 11 of the doughnut-shaped glass 10 are carried out.

### EXAMPLES

The present invention will be illustrated in greater detail with reference to the following Example and Comparative Example, but the invention should not be construed as being limited to the constitutions of these examples.

First, a sample composed of a large number of sheets of the doughnut-shaped glass 10 was prepared, and with respect to the end surface of the doughnut-shaped glass 10 in which the steps up to the precise lapping step 3 in FIG. 1 had been finished, an examination for confirming the state of occurrence of a defect in the end surface portion was carried out.

Here, in order to confirm the effects of the invention of this application, with respect to the doughnut-shaped glass 10 formed through from the preparation step 1 to the precise lapping step 3 (according to this application) in the production step of a doughnut-shaped glass as illustrated in FIG. 1, two kinds of glass substrates including one having a shallow polishing amount (depth) D₁ of 20 μm (A type, see FIG. 2(C)) and one having a deep polishing amount (depth) D₂ of 52 μm (B type, see FIG. 2(B)), each in the pre-polishing of the pre-polishing step 2A, were produced.

Then, in the doughnut-shaped glass formed through all of the steps up to the post-polishing (mirror finishing on the end surface) step 3, with respect to the two kinds of doughnut-shaped glasses including the A type and the B type, the number of occurrence of a defect on the end surface was evaluated and observed by an optical microscope. The results obtained are shown in Table 1.

TABLE 1

| | | Number of occurrence of end | | |
|---|---|---|---|---|
| | Number of | surface defects after lapping | | |
| Sample No. | samples | Crack | Scratch | Total sum |
| A type | 180 sheets | 19 | 18 | 37 |
| (End surface mirror polishing | | (10.6%) | (10.0%) | (20.6%) |
| at a depth of D₁ = 20 μm) | | | | |
| (Comparative Example) | | | | |
| B type | 174 sheets | 0 | 5 | 5 |
| (End surface mirror polishing | | (0.0%) | (2.9%) | (2.9%) |
| at a depth of D₂ = 52 μm) | | | | |
| (Invention Example) | | | | |

(Note)
Of the data shown by two steps for each item, the percentage shown in the lower step expresses the ratio of the number of occurrence of end surface defects (cracks/scratches) relative to the total number of samples in each of the A and B types, and the ratio of the total sum of end surface defects relative to the total number of samples in each of the A and B types.

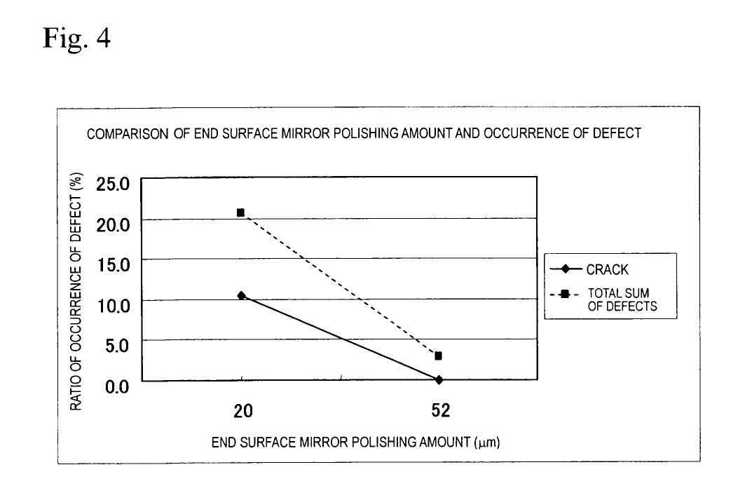

According to this comparative experiment, in the type A having a shallow polishing amount (depth) as the Comparative Example, since a crack α cannot be completely removed as illustrated in FIG. 2(C), the crack α remains. Thereafter, this remaining crack α grows and extends during the course to the post-polishing step 2B, and is observed as a crack or a defect. Incidentally, as shown in FIG. 4, in this type A having a shallow polishing amount (depth) as the Comparative Example, it could be confirmed that the total number of cracks is slightly over 10% of the whole and that the total sum of defects reaches slightly over 20%.

On the other hand, as illustrated in FIG. 2(B), in the type B having a deep polishing amount (depth) as the Invention Example, since the crack α can be completely removed, such a matter that thereafter grows during the course to the post-polishing step 2B and is observed as a crack or a defect is not substantially seen. Incidentally, as shown in FIG. 4, in this type B having a deep polishing amount (depth) as the Invention Example, it could be confirmed that even the total sum of defects can be greatly reduced to about slightly below 3%.

Thereby, there has been obtained a finding that when not only the polishing treatment is carried out once as in the conventional technology in the post-polishing step 2B before the treatment in the main polishing step 4 of polishing and mirror finishing the main surface 11 of the doughnut-shaped glass 10, but the polishing treatment is also carried out before the precise lapping step 3 of precisely grinding the main surface to a prescribed depth (52 μm in this comparative experiment) deeper than the polishing depth in the foregoing post-polishing treatment, the occurrence of a crack and a defect can be inhibited to close to almost zero.

It should be construed that the invention is never limited to the foregoing embodiments, and the invention can be carried out in various forms to the extent not deviating from the gist thereof.

The specification, claims, drawings and abstract of Japanese Patent Application No. 2007-203158 filed Aug. 3, 2007 are cited herein in their entirety and incorporated herein as disclosure of the specification of the invention.

### INDUSTRIAL APPLICABILITY

According to the method for producing a glass substrate for magnetic disk of the invention, it is possible to remove almost all of cracks that occurred before the lapping step and have a depth not more than the usually assumed deepest depth. Accordingly, the invention is useful for a method for producing a glass substrate for (magnetic) disk for storage devices in portable equipment required to have high durability and impact resistance, such as PDA or cellular phone terminals, etc.

1. A method for producing a glass substrate for magnetic disk, comprising:
a step of preparing a circular glass substrate having a main surface, a back surface opposing to the main surface, an inner side surface defining a through-hole penetrating from the main surface to the back surface, and an outer side surface opposing to the inner side surface;
a first polishing step of polishing the inner side surface and the outer side surface of the glass substrate;
a step of lapping the polished glass substrate; and
a second polishing step of polishing the inner side surface and the outer side surface of the lapped glass substrate.

2. The method for producing a glass substrate for magnetic disk according to claim 1, wherein
the polishing amount to the glass substrate in the first polishing step is larger than the polishing amount to the glass substrate in the second polishing step.

3. The method for producing a glass substrate for magnetic disk according to claim 1, wherein
the inner side surface and the outer side surface of the glass substrate polished in the second polishing step are mirror surfaces having an arithmetic average roughness of from 50 nm to 100 nm.

4. The method for producing a glass substrate for magnetic disk according to claim 2, wherein
the inner side surface and the outer side surface of the glass substrate polished in the second polishing step are mirror surfaces having an arithmetic average roughness of from 50 nm to 100 nm.

5. A glass substrate for magnetic disk, produced by the method for producing a glass substrate for magnetic disk according to any one of claims 1 to 4.
